(19) United States
(12) Patent Application Publication
(10) Pub. No.: US 2026/0230112 A1
(43) Pub. Date: Aug. 6, 2026

(54) ENERGY-BASED DISCONTINUOUS BACKSCATTERING BY AN AMBIENT INTERNET-OF-THINGS DEVICE

(71) Applicant: QUALCOMM Incorporated, San Diego, CA (US)

(72) Inventors: Chao WEI, Beijing (CN); Min HUANG, Beijing (CN); Jing DAI, Beijing (CN)

(21) Appl. No.: 19/146,410

(22) PCT Filed: Feb. 16, 2023
(86) PCT No.: PCT/CN2023/076400

§ 371 Date: Jul. 8, 2025

(51) Int. Cl. H04B 5/45

(52) U.S. Cl. CPC H04B 5/45

(57) ABSTRACT

Various aspects of the present disclosure generally relate to wireless communication. In some aspects, a passive backscatter device may receive a configuration associated with transmitting a transport block using discontinuous backscattering. The passive backscatter device may transmit the transport block using discontinuous backscattering based at least in part on the configuration, the transport block being transmitted over a plurality of bursts. Numerous other aspects are described.

### FIELD OF THE DISCLOSURE

Aspects of the present disclosure generally relate to wireless communication and to techniques and apparatuses for energy-based discontinuous backscattering by an ambient internet-of-things (AIoT) device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a passive backscatter device. The method may include receiving a configuration associated with transmitting a transport block using discontinuous backscattering. The method may include transmitting the transport block using discontinuous backscattering based at least in part on the configuration, the transport block being transmitted over a plurality of bursts.

Some aspects described herein relate to a passive backscatter device for wireless communication. The passive backscatter device may include a memory and one or more processors coupled to the memory. The one or more processors may be configured to receive a configuration associated with transmitting a transport block using discontinuous backscattering. The one or more processors may be configured to transmit the transport block using discontinuous backscattering based at least in part on the configuration, the transport block being transmitted over a plurality of bursts.

Some aspects described herein relate to a non-transitory computer-readable medium that stores a set of instructions for wireless communication by a passive backscatter device. The set of instructions, when executed by one or more processors of the passive backscatter device, may cause the passive backscatter device to receive a configuration associated with transmitting a transport block using discontinuous backscattering. The set of instructions, when executed by one or more processors of the passive backscatter device, may cause the passive backscatter device to transmit the transport block using discontinuous backscattering based at least in part on the configuration, the transport block being transmitted over a plurality of bursts.

Some aspects described herein relate to an apparatus. The apparatus may include means for receiving a configuration associated with transmitting a transport block using discontinuous backscattering. The apparatus may include means for transmitting the transport block using discontinuous backscattering based at least in part on the configuration, the transport block being transmitted over a plurality of bursts.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of backscatter communications utilizing ambient Internet-of-Things (AIoT) technology.

FIGS. 4A-4G are diagrams illustrating examples associated with energy-based discontinuous backscattering by an AIoT device, in accordance with the present disclosure.

FIG. 5 is a diagram illustrating an example process performed, for example, by a passive backscatter device, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

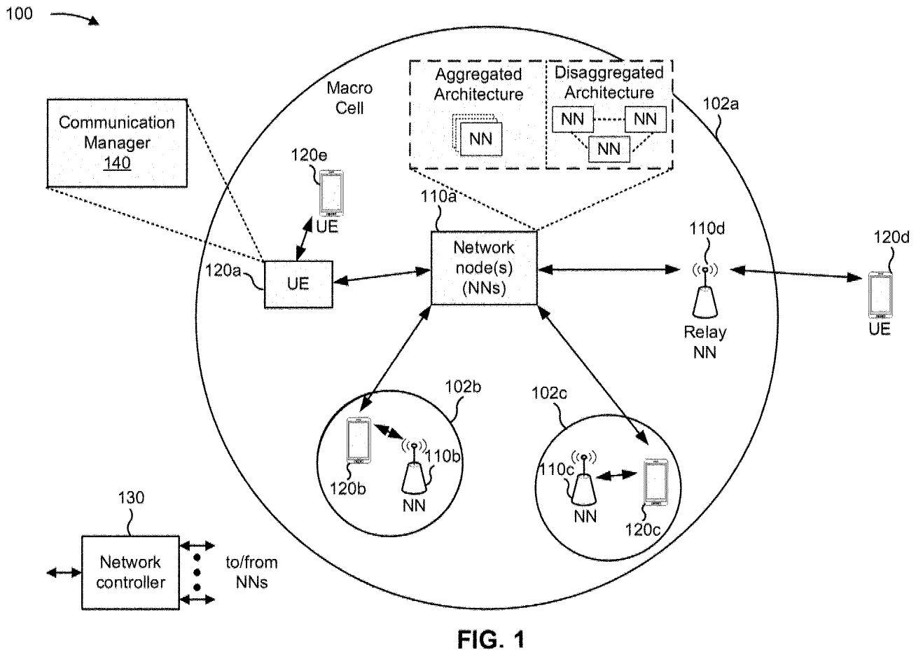

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G) FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered ambient IoT (AIoT) devices (also referred to as a passive backscatter device, a tag, a backscatter UE (BUE) or a passive UE (PUE)). Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHZ). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a passive backscatter device (e.g., a UE 120 in the form of an AIoT device) may include a communication manager 140. As described in more detail elsewhere herein, the communication manager 140 may receive a configuration associated with transmitting a transport block using discontinuous backscattering, and transmit the transport block using discontinuous backscattering based at least in part on the configuration, the transport block being transmitted over a plurality of bursts. Additionally, or alternatively, the communication manager 140 may perform one or more other operations described herein.

As indicated above, FIG. 1 is provided as an example. Other examples may differ from what is described with regard to FIG. 1.

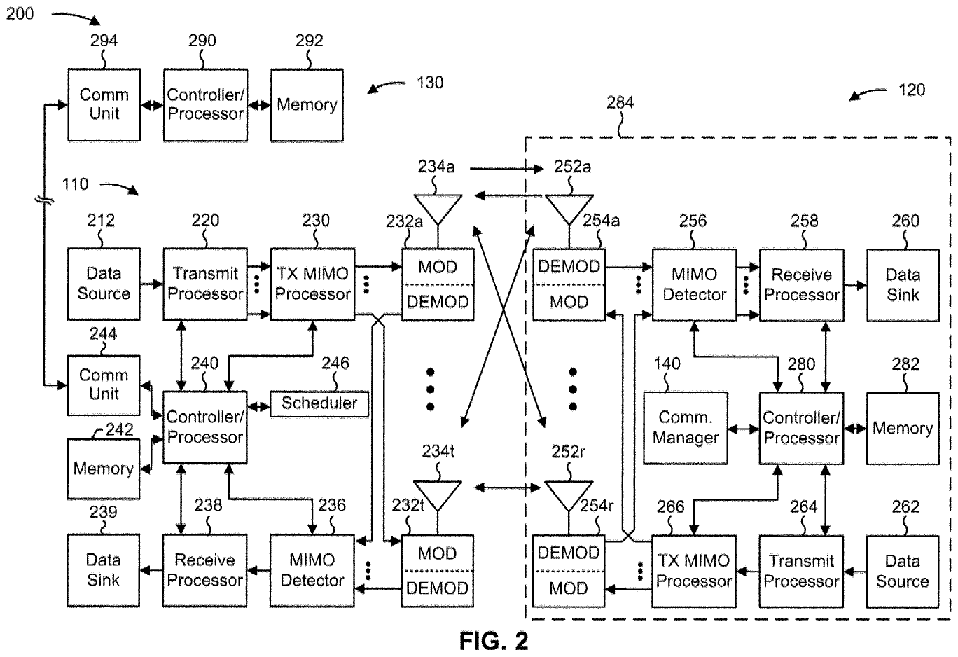

FIG. 2 is a diagram illustrating an example °of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

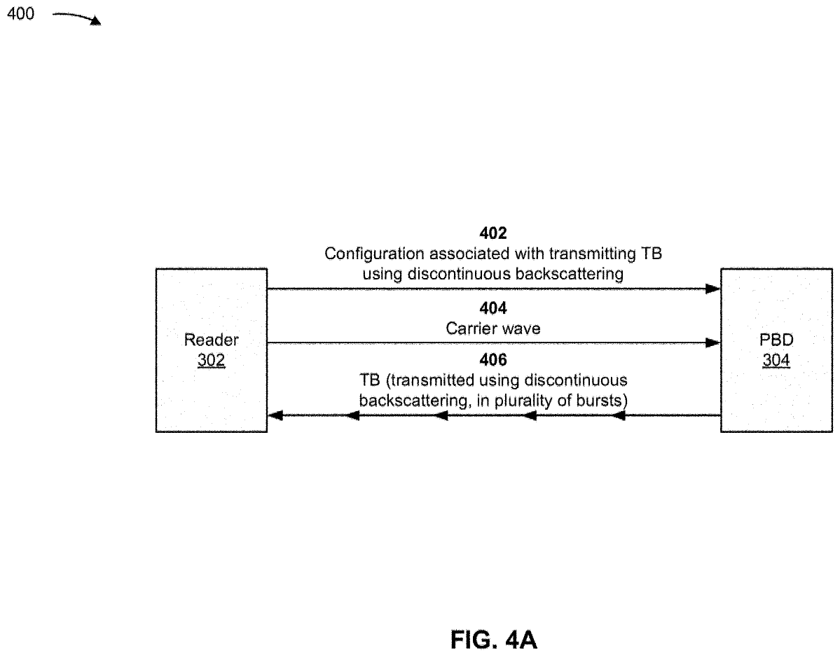

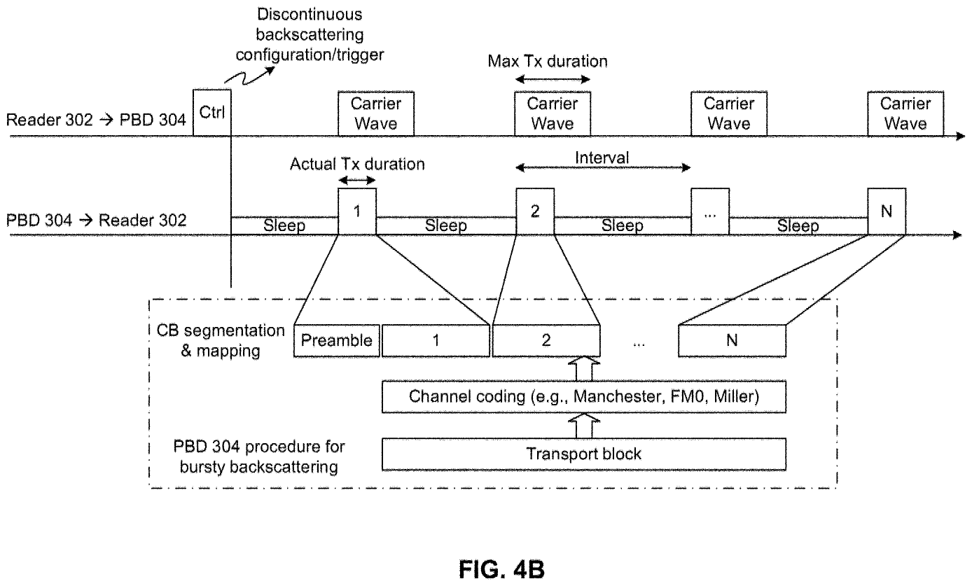

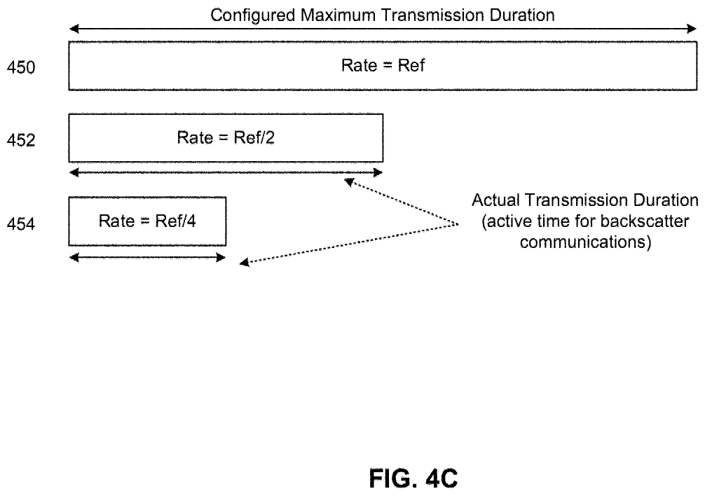

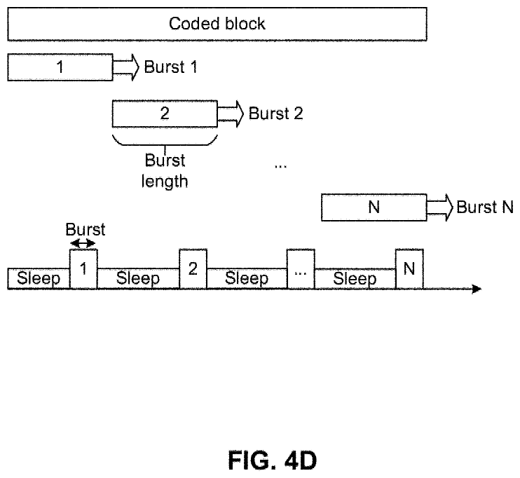

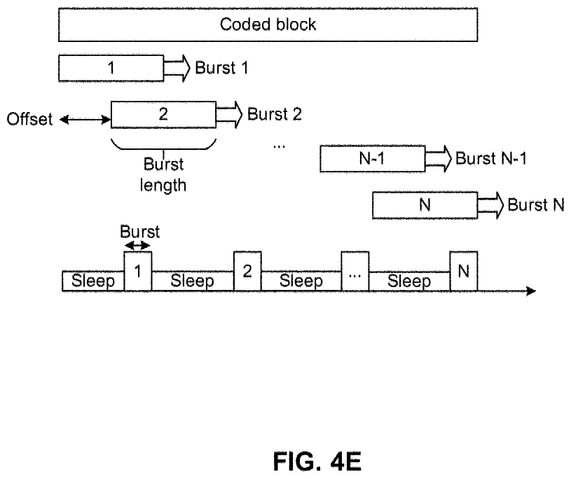

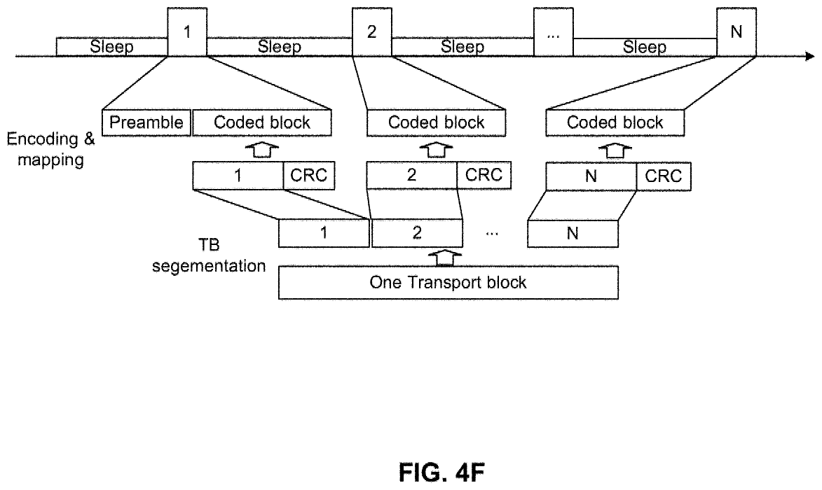

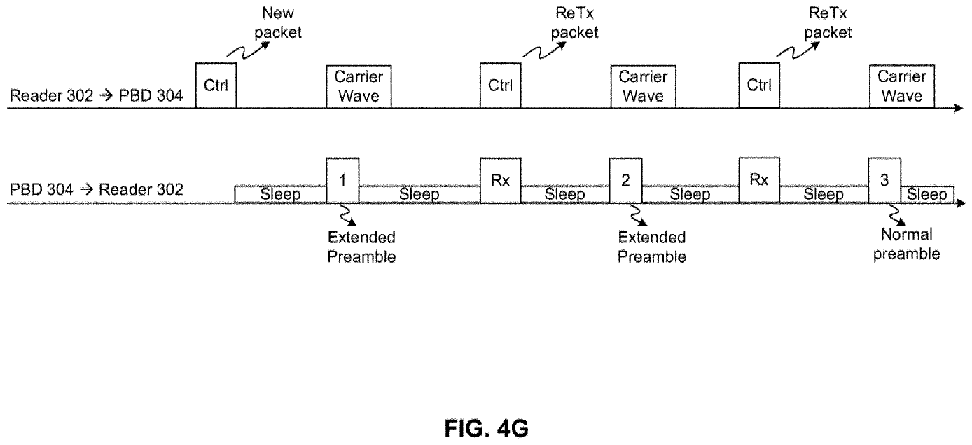

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-6).

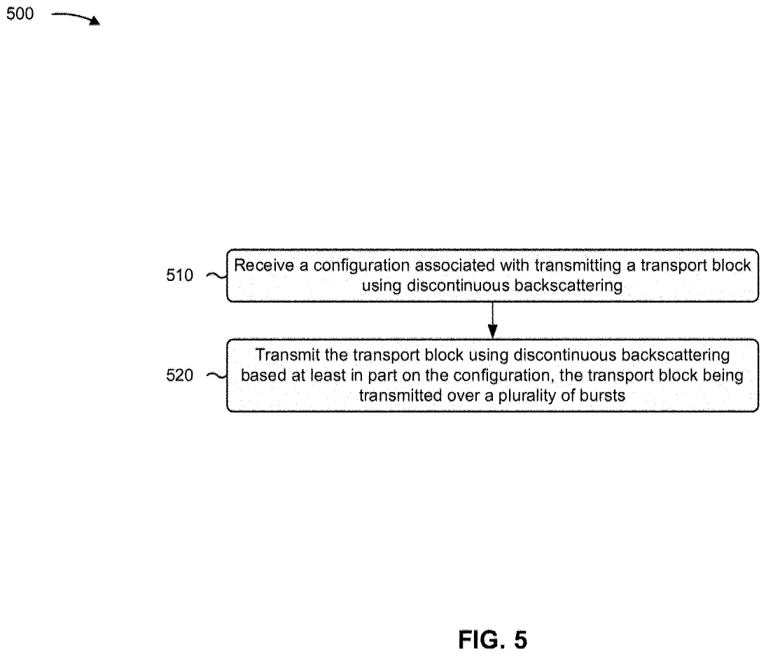

The controller/processor 240 of the network node 110, the controller/processor 280 of the UE 120, and/or any other component(s) of FIG. 2 may perform one or more techniques associated with energy-based discontinuous backscattering by an ambient internet-of-things (AIOT) device, as described in more detail elsewhere herein. For example, the controller/processor 240 of the network node 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, a passive backscatter device (e.g., a UE 120 in the form of an AIoT device) includes means for receiving a configuration associated with transmitting a transport block using discontinuous backscattering; and/or means for transmitting the transport block using discontinuous backscattering based at least in part on the configuration, the transport block being transmitted over a plurality of bursts. In some aspects, the means for the passive backscatter device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

Ambient IoT (AIOT) technology-also referred to as passive IoT technology-utilizes ultra-low complexity and ultra-low power devices and provides complexity and power consumption that are orders of magnitude lower than existing eMTC/NB-IOT technology. One example of an AIoT device is a Type A battery-less device that has no energy storage capability and, therefore, is dependent on an external source of energy. Another example of an AIoT device is a Type B battery-less device that has limited energy storage (e.g., using a capacitor, a super capacitor, or the like) that does not need to be manually replaced or recharged. Typically, an AIoT device is a passive device and does not include active RF components (i.e., the AIOT does not generate RF signals). Rather, the AIoT device performs a data transmission based on modulating an incident RF signal emitted by another device (e.g., a network node 110 or a UE 120). Here, the ambient RF signal can serve as a carrier wave for backscattering by the AIOT and as a resource for energy harvesting by the AIoT device.

Notably, RF identification (RFID) technology is an existing battery-less technology. However, RFID technology has a limited range of a few meters and, therefore, large-scale deployment with seamless coverage cannot be achieved.

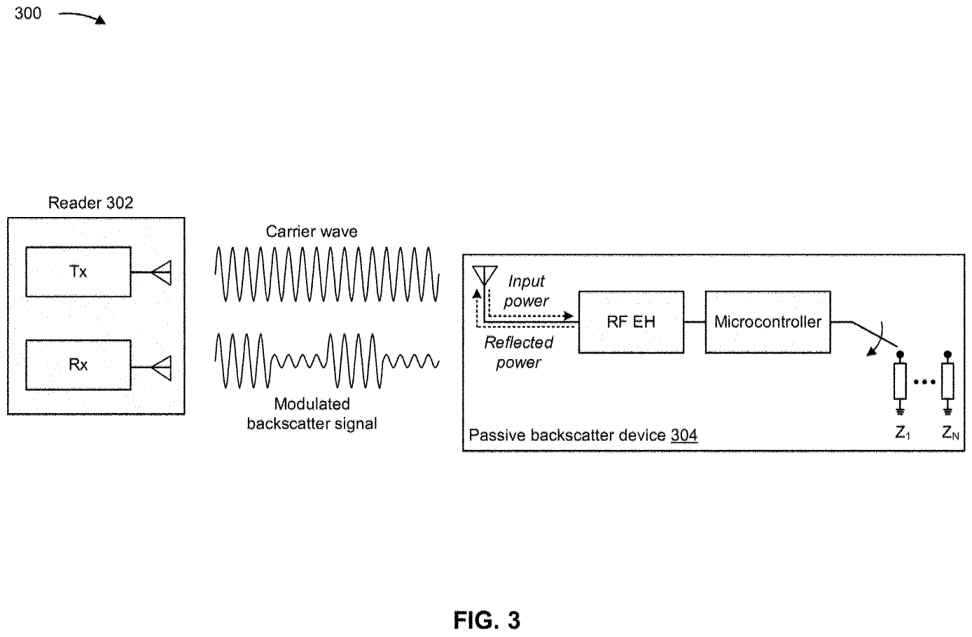

FIG. 3 is a diagram illustrating an example 300 of backscatter communications utilizing AIoT technology. As shown, example 300 includes a reader 302 (e.g., a UE 120, a network node 110, or the like) and a passive backscatter device 304 (e.g., a UE 120 in the form of an AIoT device).

For backscatter communication, the passive backscatter device 304 can perform information transmission using antenna modulation (e.g., without active RF generation). For example, as illustrated in example 300, the reader 302 transmits a carrier wave that is received at the passive backscatter device 304. In this example, the passive backscatter device 304 tunes a reflection coefficient of its antenna (e.g., by switching over a given set of impedances, as illustrated in FIG. 3), which results in a varying amount of the incident RF signal to be backscattered from the passive backscatter device 304. For example, if the passive backscatter device 304 is configured to use binary phase-shift keying (BPSK) modulation, then the passive backscatter device 304 may switch a value of load impedance between a high impedance and a relatively matched load. In the high impedance case, the mismatch between the antenna and the load impedance reflects all of the power back to the reader 302. Conversely, in the matched impedance case, a majority of the power from the incident RF signal is absorbed, and relatively little power is reflected to the reader 302. In some implementations, an impedance switching frequency utilized by the passive backscatter device 304 is based on a data rate. In this way, the passive backscatter device 304 may provide a modulated backscatter signal. Notably, the use of amplitude shift-keying (ASK) to provide the modulated backscatter signal is one example, and other modulation techniques are possible. For example, the passive backscatter device 304 may in some aspects modulate an amplitude, a phase, and/or a frequency of the incident RF signal (via antenna/load modulation) to provide the modulated backscatter signal using another type of modulation technique.

As indicated above, FIG. 3 is provided as an example. Other examples may differ from what is described with regard to FIG. 3.

An AIoT device may have power available intermittently, meaning that the AIOT device cannot generally be active for a long period of time. A length of an active time period of the AIOT device can be determined by a capacity of the AIoT to store energy. For example, with 1.5 volts (V) and 10 microamps (μA) assumed, an AIoT device with a fully charged capacitor of 24 microfarads (μF) may be active for approximately 3.6 seconds(s) (e.g., 24 μF×1.5 V=36 microcoulombs (μC) =3.6 μA=10 μA×3.6 s). Energy harvested by the AIoT device from the carrier wave needs to balance energy demand for communication, computation, or another purpose (e.g., powering sensors), and power consumption determines the active time period for communication. In general, the AIOT device may transmit comparatively shorter bursts at comparatively higher power or may transmit comparatively longer bursts at comparatively lower power.

A data rate of an AIoT device is typically low (e.g., in a range from approximately several kilobits per second (kbps) to approximately 100 kbps), meaning that a single packet cannot be transmitted in a 1 millisecond (ms) time period (e.g., a 1 ms subframe). For example, in an asset tracking application, a message size is approximately 256 bits (e.g., 128 bits device identity plus 128 bits for control or other data). Here, a transmission duration of 1 ms requires a data rate of 256 kbps, meaning that the single packet cannot be transmitted in the 1 ms timeframe.

Additionally, for AIoT deployment in a same frequency band as that used for other communications, transmission of a carrier wave to an AIoT device should follow a non-continuous uplink/downlink slot structure. For example, for AIoT deployment in a same frequency band as that used for NR communications, transmission of a carrier wave to an AIoT device should follow a non-continuous uplink/downlink slot structure utilized for NR time-division duplexing (TDD). As a result, the ambient IoT device cannot continuously transmit/backscatter a signal to a reader in a wireless communication system such as an NR TDD system (even when there is sufficient power available to the AIoT device).

One technique to address these issues is to implement packet segmentation at a higher layer, dependent on available transmission resources. However, packet segmentation results in additional signaling overhead for each segment. Further, packet segmentation lacks consideration for an amount of available power at an AIoT device.

Some aspects described herein provide techniques and apparatuses for energy-based discontinuous backscattering by an AIoT device (herein referred to a passive backscatter device). In some aspects, a passive backscatter device may receive a configuration associated with transmitting a transport block using discontinuous backscattering. The passive backscatter device may then transmit the transport block using discontinuous backscattering based at least in part on the configuration, with the transport block being transmitted over a plurality of bursts. In some aspects, the techniques and apparatuses described herein enable a passive backscatter device to be configured such that an active time (e.g., a time period during which the passive backscatter device transmits a transport block using discontinuous backscattering) may be adapted based at least in part on an amount of power harvested by the passive backscatter device and an estimated power consumption for backscattering. Further, the techniques and apparatuses described herein enable AIoT deployment in a same frequency band as that used for other communications, such as a frequency band used for NR communications in an NR TDD system. Additional details are provided below.

FIGS. 4A-4G are diagrams illustrating examples associated with energy-based discontinuous backscattering by an AIoT device, in accordance with the present disclosure. In an example 400 shown in FIG. 4A, wireless communication may occur between a reader 302 and a passive backscatter device 304. The reader 302 may be, for example, a UE 120 or a network node 110. The passive backscatter device 304 may be, for example, a UE 120 in the form of an AIOT device.

As shown in FIG. 4A at reference 402, the passive backscatter device 304 may receive a configuration associated with transmitting a transport block using discontinuous backscattering. That is, the passive backscatter device 304 may be configured with a configuration for discontinuous backscattering for transmitting a transport block. In some aspects, the configuration indicates one or more parameters based at least in part on which the passive backscatter device 304 is to transmit a transport block using discontinuous backscattering. For example, the configuration may indicate a transport block size (e.g., a size of the transport block). As another example, the configuration may indicate a reference backscatter link rate (e.g., a reference data rate associated with transmission of the transport block). In some aspects, the reference backscatter link rate is associated with a frequency for switching load impedances of the passive backscatter device 304. As another example, the configuration may indicate a quantity of bursts in which the transport block can be transmitted. As another example, the configuration may indicate a time interval between bursts. As another example, the configuration may indicate a maximum per-burst transmission duration (e.g., an active time of a given burst).

In some aspects, the configuration may be pre-configured on the passive backscatter device 304 (e.g., the passive backscatter device 304 may receive the configuration prior to receiving a trigger to transmit the transport block). Additionally, or alternatively, the passive backscatter device 304 may receive the configuration in a command (e.g., a downlink command) that triggers the passive backscatter device 304 to transmit the transport block using discontinuous backscattering (e.g., the passive backscatter device 304 may receive the configuration concurrently with receiving a trigger to transmit the transport block).

As shown at reference 404, the passive backscatter device 304 may receive a carrier wave (e.g., an RF signal emitted by the reader 302).

As shown at reference 406, the passive backscatter device 304 may transmit the transport block using discontinuous backscattering based at least in part on the configuration, with the transport block being transmitted over a plurality of bursts. For example, the passive backscatter device 304 may receive the carrier wave emitted by the reader 302, and may transmit the transport block using discontinuous backscattering based at least in part on the configuration.

In some aspects, an actual backscatter link rate associated with transmitting the transport block (e.g., a data rate at which the passive backscatter device 304 actually transmits the transport block) is higher than the reference backscatter link rate. In such a case, an actual transmission duration of a burst of the plurality of bursts is shorter than the maximum per-burst transmission. That is, if the passive backscatter device 304 uses a higher data rate (e.g., based on the availability of power to the passive backscatter device 304), then the actual transmission duration for a given burst can be lower than the configured maximum per-burst duration. In some aspects, the actual backscatter link rate may depend on an amount of power harvested by the passive backscatter device 304 and an estimated power consumption for backscattering. In some aspects, a mapping between an actual transmission duration of a burst of the plurality of bursts and an actual backscatter link rate associated with transmitting the transport block is predefined (e.g., one-half of the transmission duration can be used for two times a data rate).

In some aspects, the passive backscatter device 304 may transmit control information (e.g., a preamble) associated with transmitting the transport block using discontinuous backscattering. For example, the passive backscatter device 304 may transmit control information indicating an actual transmission duration of a burst of the plurality of bursts. As another example, the passive backscatter device 304 may transmit control information indicating an actual backscatter link rate associated with transmitting the transport block. In some aspects, the passive backscatter device 304 may transmit the control information at a start of a first-in-time burst of the plurality of bursts and using the reference backscatter link rate.

FIG. 4B is a diagram illustrating an example of energy-based transmission using discontinuous backscattering as performed by the passive backscatter device 304. As shown in the lower portion of FIG. 4B, the passive backscatter device 304 may perform channel coding of the transport block, and then perform coded block (CB) segmentation and mapping to form N segments. In some aspects, control information may be included in the preamble (e.g., the first segment illustrated in FIG. 4B).

As shown in the upper portion of FIG. 4B, the reader 302 may transmit, and the passive backscatter device 304 may receive, a configuration associated with transmitting a transport block using discontinuous backscattering. In this example, the configuration is included in control information that triggers the passive backscatter device 304 to transmit the transport block using discontinuous backscattering. As further shown, the reader 302 may periodically transmit a carrier wave for reception by the passive backscatter device 304 and use for discontinuous backscattering. As shown, each transmission of the carrier wave may continue for a period of time corresponding to a maximum per-burst transmission duration and, in this example, the reader 302 may perform N transmissions of the carrier wave.

The passive backscatter device 304 may receive the carrier wave in each of the N transmissions, and may transmit the transport block using discontinuous backscattering based at least in part on the configuration, with the transport block being transmitted over N bursts. As shown in FIG. 4B, an actual transmission duration of a given burst may be shorter than the maximum per-burst transmission duration. In such a case, the passive backscatter device 304 may include information indicating the actual transmission duration in the control information transmitted in the preamble.

In some aspects, a transmission duration of a given burst of the plurality of bursts (also referred to as an active time) can be adapted based at least in part on an amount of power available to the passive backscatter device 304. For example, based at least in part on the amount of available power, the passive backscatter device 304 may adapt the transmission duration of a burst such that an actual transmission duration is different from (e.g., shorter than) the configured maximum per-burst transmission duration. In one example, the passive backscatter device 304 may adapt the burst transmission duration based on an actual backscatter link rate associated with transmitting the transport block, which corresponds to a frequency for switching of antenna impedance at the passive backscatter device 304 (e.g., with comparatively higher frequencies resulting in higher power consumption). In some aspects, the passive backscatter device 304 may adapt the transmission duration based at least in part on one or more other factors, such as a modulation and coding scheme used in association with transmitting the transport block.

FIG. 4C is a diagram illustrating an example associated with adaptation of a burst transmission duration. As shown at reference 450 in FIG. 4C, and as noted above, the configured maximum per-burst transmission duration may be associated with the reference backscatter link rate. As shown at reference 452, the passive backscatter device 304 may, in some aspects, adapt a burst transmission duration such that the burst transmission duration is approximately one-half of the maximum per-burst transmission duration, which corresponds to an actual backscatter link rate that is approximately one-half of the reference backscatter link rate. As shown at reference 454, the passive backscatter device 304 may, in some aspects, adapt a burst transmission duration such that the burst transmission duration is approximately one-quarter of the maximum per-burst transmission duration, which corresponds to an actual backscatter link rate that is approximately one-quarter of the reference backscatter link rate.

In some aspects, the passive backscatter device 304 may map a coded block associated with the transport block to the plurality of bursts using a continuous mapping. FIG. 4D is a diagram illustrating an example of mapping of a coded block to the plurality of bursts using a continuous mapping. In such an aspect, as illustrated in FIG. 4D, a given burst starts from an end of a previous burst. That is, in the case of continuous mapping, a start of a burst of the plurality of bursts may correspond to an end of a previous burst of the plurality of bursts. In some aspects, the use of continuous mapping reduces overhead associated with transmitting the transport block.

Alternatively, the passive backscatter device 304 may, in some aspects, map a coded block associated with the transport block to the plurality of bursts using a non-continuous mapping with an offset. FIG. 4E is a diagram illustrating an example of mapping of a coded block to the plurality of bursts using a non-continuous mapping with an offset. In such an aspect, as illustrated in FIG. 4E, a start of a second burst is delayed by the offset (e.g., from a start of a first burst) to create an overlap between the first and second bursts. That is, in the case of non-continuous mapping with an offset, a start of a burst of the plurality of bursts is delayed by the offset with respect to a start of a previous burst of the plurality of bursts. In some aspects, the use of non-continuous mapping improves reliability of transmission of the transport block by increasing redundancy.

In some aspects, the passive backscatter device 304 may apply transport block segmentation such that each burst of the plurality of bursts is separately decodable and is appended with one or more cyclic redundancy check (CRC) bits. In such an aspect, independent hybrid automatic repeat request (HARQ) acknowledgment (ACK) feedback for each burst can be supported for transmission of the transport block. For example, the reader 302 may transmit, and the passive backscatter device 304 may receive, feedback information (e.g., a HARQ-ACK feedback bitmap) associated with each burst of the plurality of bursts after transmission of the last burst of the plurality of bursts. In this way, the passive backscatter device 304 may be indicated to retransmit only those bursts that were not successfully received and decoded (e.g., rather than retransmitting all bursts). FIG. 4F is a diagram illustrating an example in which the passive backscatter device 304 applies transport block segmentation such that each burst of the plurality of bursts is separately decodable and is appended with one or more CRC bits.

In some aspects, the passive backscatter device 304 may receive an indication to terminate transmission of the transport block prior to transmitting a last burst of the plurality of bursts. In some aspects, the passive backscatter device 304 may not expect to receive a communication (e.g., including control information or a trigger) between a start of the first burst and an end of the last burst. However, in some aspects, the passive backscatter device 304 may be configured with early termination such that the passive backscatter device 304 can receive an indication to terminate transmission of the transport block early. For example, when a coding rate is relatively low, the reader 302 may decode the transport block without receiving all bursts. In such a case, the reader 302 may transmit a command including an indication to terminate transmission of the transport block early (e.g., to cause the passive backscatter device 304 to stop backscattering for remaining bursts).

In some aspects, the passive backscatter device 304 may encode the transport block using Miller coding. In such an aspect, a sequence for a first symbol of a burst of the plurality of bursts may be based at least in part on a last symbol of a previous burst of the plurality of bursts. That is, if the passive backscatter device 304 uses Miller-M (e.g., M=2, 4, 8, or the like) coding for encoding the transport block, to exploit memory of the Miller code, a sequence for a first symbol of a burst can be dependent on a last symbol of a prior burst. In some aspects, when using Miller coding to encode the transport block, the passive backscatter device 304 may insert a bit (e.g., a “dummy” bit) indicating termination of the Miller coding at an end of a last burst of the plurality of bursts (but not in every burst). Alternatively, a sequence for a first symbol of a burst of the plurality of bursts is not dependent on a last symbol of a previous burst of the plurality of bursts, and the passive backscatter device 304 may insert a bit (e.g., a “dummy” bit) at the end of each burst (e.g., to enable independent Miller coding per burst).

In some aspects, the passive backscatter device 304 may transmit an indication associated with initiating a subsequent transmission for transmitting a portion of the transport block. Thus, the passive backscatter device 304 may, in some aspects, initiate transmission of a portion of the transport block using discontinuous backscattering. In some aspects, the indication may be provided via, for example, an end-of-signaling or an extended preamble. In some aspects, the extended preamble may have one or more bits (e.g., one or more data-0 bits) prepended to a preamble, where the one or more prepended bits indicate that the transport block was partially transmitted (e.g., due to lack of power) and indicate a request for scheduling a subsequent transmission for the (remaining) portion of the transport block. In some aspects, the passive backscatter device 304 may then receive an indication to transmit the subsequent transmission including the portion of the transport block. That is, the passive backscatter device 304 may receive another trigger signal (e.g., including a retransmission (ReTx) indication) to perform the subsequent transmission for the remaining portion of the transport block. FIG. 4G is a diagram illustrating an example in which the passive backscatter device 304 transmits an indication to initiate a subsequent transmission, receives an indication to transmit the subsequent transmission, and transmits the subsequent transmission accordingly.

FIG. 5 is a diagram illustrating an example process 500 performed, for example, by a passive backscatter device, in accordance with the present disclosure. Example process 500 is an example where the passive backscatter device (e.g., UE 120, passive backscatter device 304, or the like) performs operations associated with energy-based discontinuous backscattering.

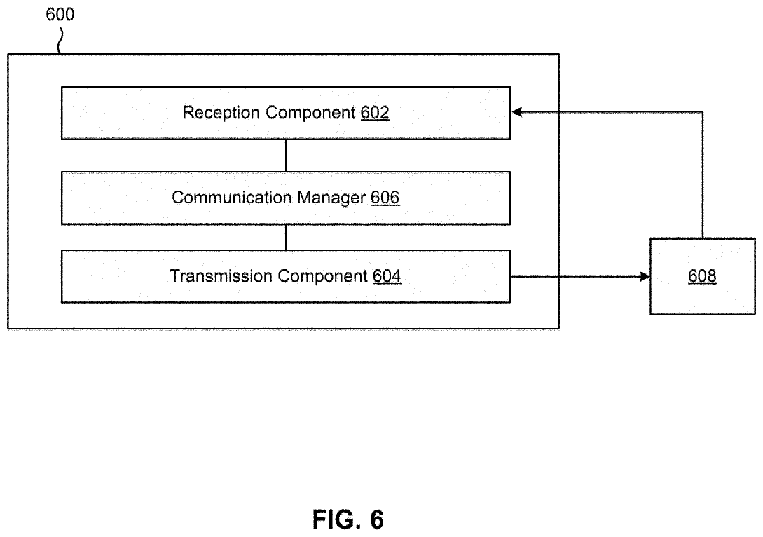

As shown in FIG. 5, in some aspects, process 500 may include receiving a configuration associated with transmitting a transport block using discontinuous backscattering (block 510). For example, the passive backscatter device (e.g., using reception component 602 and/or communication manager 606, depicted in FIG. 6) may receive a configuration associated with transmitting a transport block using discontinuous backscattering, as described above.

As further shown in FIG. 5, in some aspects, process 500 may include transmitting the transport block using discontinuous backscattering based at least in part on the configuration, the transport block being transmitted over a plurality of bursts (block 520). For example, the passive backscatter device (e.g., using transmission component 604 and/or communication manager 606, depicted in FIG. 6) may transmit the transport block using discontinuous backscattering based at least in part on the configuration, the transport block being transmitted over a plurality of bursts, as described above.

Process 500 may include additional aspects, such as any single aspect or any combination of aspects described below and/or in connection with one or more other processes described elsewhere herein.

In a first aspect, the configuration indicates at least one of a transport block size, a reference backscatter link rate, a quantity of bursts, a time interval between bursts, or a maximum per-burst transmission duration.

In a second aspect, alone or in combination with the first aspect, the maximum per-burst transmission duration is associated with the reference backscatter link rate.

In a third aspect, alone or in combination with one or more of the first and second aspects, the reference backscatter link rate is associated with a frequency for switching load impedances of the passive backscatter device.

In a fourth aspect, alone or in combination with one or more of the first through third aspects, an actual backscatter link rate associated with transmitting the transport block is higher than a reference backscatter link rate indicated by the configuration, and an actual transmission duration of a burst of the plurality of bursts is shorter than a maximum per-burst transmission duration indicated by the configuration.

In a fifth aspect, alone or in combination with one or more of the first through fourth aspects, the actual backscatter link rate depends on an amount of power harvested by the passive backscatter device and an estimated power consumption for backscattering.

In a sixth aspect, alone or in combination with one or more of the first through fifth aspects, a mapping between an actual transmission duration of a burst of the plurality of bursts and an actual backscatter link rate associated with transmitting the transport block is predefined.

In a seventh aspect, alone or in combination with one or more of the first through sixth aspects, process 500 includes transmitting control information indicating at least one of an actual transmission duration of a burst of the plurality of bursts or an actual backscatter link rate associated with transmitting the transport block.

In an eighth aspect, alone or in combination with one or more of the first through seventh aspects, the control information is transmitted at a start of a first-in-time burst of the plurality of bursts and using a reference backscatter link rate.

In a ninth aspect, alone or in combination with one or more of the first through eighth aspects, the configuration is pre-configured on the passive backscatter device.

In a tenth aspect, alone or in combination with one or more of the first through ninth aspects, the configuration is included in a command that triggers the passive backscatter device to transmit the transport block using discontinuous backscattering.

In an eleventh aspect, alone or in combination with one or more of the first through tenth aspects, process 500 includes mapping a coded block associated with the transport block to the plurality of bursts using a continuous mapping.

In a twelfth aspect, alone or in combination with one or more of the first through eleventh aspects, a start of a burst of the plurality of bursts corresponds to an end of a previous burst of the plurality of bursts.

In a thirteenth aspect, alone or in combination with one or more of the first through twelfth aspects, process 500 includes mapping a coded block associated with the transport block to the plurality of bursts using a non-continuous mapping with an offset.

In a fourteenth aspect, alone or in combination with one or more of the first through thirteenth aspects, a start of a burst of the plurality of bursts is delayed by the offset with respect to a start of a previous burst of the plurality of bursts.

In a fifteenth aspect, alone or in combination with one or more of the first through fourteenth aspects, process 500 includes applying transport block segmentation such that each burst of the plurality of bursts is separately decodable and is appended with one or more CRC bits.

In a sixteenth aspect, alone or in combination with one or more of the first through fifteenth aspects, process 500 includes receiving feedback information associated with each burst of the plurality of bursts.

In a seventeenth aspect, alone or in combination with one or more of the first through sixteenth aspects, process 500 includes receiving an indication to terminate transmission of the transport block, the indication being received prior to transmitting a last burst of the plurality of bursts.

In an eighteenth aspect, alone or in combination with one or more of the first through seventeenth aspects, process 500 includes encoding the transport block using Miller coding, wherein a sequence for a first symbol of a burst of the plurality of bursts is based at least in part on a last symbol of a previous burst of the plurality of bursts.

In a nineteenth aspect, alone or in combination with one or more of the first through eighteenth aspects, encoding the transport block comprises inserting a bit indicating termination of the Miller coding at an end of a last burst of the plurality of bursts.

In a twentieth aspect, alone or in combination with one or more of the first through nineteenth aspects, process 500 includes transmitting an indication associated with initiating a subsequent transmission for transmitting a portion of the transport block.

In a twenty-first aspect, alone or in combination with one or more of the first through twentieth aspects, the indication includes at least one of an end-of-signaling or an extended preamble.

In a twenty-second aspect, alone or in combination with one or more of the first through twenty-first aspects, the indication indicates that the transport block was partially transmitted and includes a request for scheduling the subsequent transmission for transmitting the portion of the transport block.

In a twenty-third aspect, alone or in combination with one or more of the first through twenty-second aspects, process 500 includes receiving an indication to transmit the subsequent transmission including the portion of the transport block.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a passive backscatter device, or a passive backscatter device may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 140 described in connection with FIG. 1. As shown, the apparatus 600 may communicate with another apparatus 608, such as a UE or a network node (such as a CU, a DU, an RU, or a base station), using the reception component 602 and the transmission component 604.

In some aspects, the apparatus 600 may be configured to perform one or more operations described herein in connection with FIGS. 4A-4G. Additionally, or alternatively, the apparatus 600 may be configured to perform one or more processes described herein, such as process 500 of FIG. 5. In some aspects, the apparatus 600 and/or one or more components shown in FIG. 6 may include one or more components of the passive backscatter device described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the passive backscatter device described in connection with FIG. 2.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 608. In some aspects, the transmission component 604 may include one or more antennas, a modem, a modulator, a transmit MIMO processor, a transmit processor, a controller/processor, a memory, or a combination thereof, of the passive backscatter device described in connection with FIG. 2. In some aspects, the transmission component 604 may be co-located with the reception component 602 in a transceiver.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The reception component 602 may receive a configuration associated with transmitting a transport block using discontinuous backscattering. The transmission component 604 may transmit the transport block using discontinuous backscattering based at least in part on the configuration, the transport block being transmitted over a plurality of bursts.

The transmission component 604 may transmit control information indicating at least one of an actual transmission duration of a burst of the plurality of bursts or an actual backscatter link rate associated with transmitting the transport block.

The communication manager 606 may map a coded block associated with the transport block to the plurality of bursts using a continuous mapping.

The communication manager 606 may map a coded block associated with the transport block to the plurality of bursts using a non-continuous mapping with an offset.

The communication manager 606 may apply transport block segmentation such that each burst of the plurality of bursts is separately decodable and is appended with one or more CRC bits.

The reception component 602 may receive feedback information associated with each burst of the plurality of bursts.

The reception component 602 may receive an indication to terminate transmission of the transport block, the indication being received prior to transmitting a last burst of the plurality of bursts.

The communication manager 606 may encode the transport block using Miller coding, wherein a sequence for a first symbol of a burst of the plurality of bursts is based at least in part on a last symbol of a previous burst of the plurality of bursts.

The transmission component 604 may transmit an indication associated with initiating a subsequent transmission for transmitting a portion of the transport block.

The reception component 602 may receive an indication to transmit the subsequent transmission including the portion of the transport block.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components.

Additionally, or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed by a passive backscatter device, comprising: receiving a configuration associated with transmitting a transport block using discontinuous backscattering; and transmitting the transport block using discontinuous backscattering based at least in part on the configuration, the transport block being transmitted over a plurality of bursts.
Aspect 2: The method of Aspect 1, wherein the configuration indicates at least one of a transport block size, a reference backscatter link rate, a quantity of bursts, a time interval between bursts, or a maximum per-burst transmission duration.
Aspect 3: The method of Aspect 2, wherein the maximum per-burst transmission duration is associated with the reference backscatter link rate.
Aspect 4: The method of Aspect 2, wherein the reference backscatter link rate is associated with a frequency for switching load impedances of the passive backscatter device.
Aspect 5: The method of any of Aspects 1-4, wherein an actual backscatter link rate associated with transmitting the transport block is higher than a reference backscatter link rate indicated by the configuration, and an actual transmission duration of a burst of the plurality of bursts is shorter than a maximum per-burst transmission duration indicated by the configuration.
Aspect 6: The method of Aspect 5, wherein the actual backscatter link rate depends on an amount of power harvested by the passive backscatter device and an estimated power consumption for backscattering.
Aspect 7: The method of any of Aspects 1-6, wherein a mapping between an actual transmission duration of a burst of the plurality of bursts and an actual backscatter link rate associated with transmitting the transport block is predefined.
Aspect 8: The method of any of Aspects 1-7, further comprising transmitting control information indicating at least one of an actual transmission duration of a burst of the plurality of bursts or an actual backscatter link rate associated with transmitting the transport block.
Aspect 9: The method of Aspect 8, wherein the control information is transmitted at a start of a first-in-time burst of the plurality of bursts and using a reference backscatter link rate.
Aspect 10: The method of any of Aspects 1-9, wherein the configuration is pre-configured on the passive backscatter device.
Aspect 11: The method of any of Aspects 1-10, wherein the configuration is included in a command that triggers the passive backscatter device to transmit the transport block using discontinuous backscattering.
Aspect 12: The method of any of Aspects 1-11, further comprising mapping a coded block associated with the transport block to the plurality of bursts using a continuous mapping.
Aspect 13: The method of Aspect 12, wherein a start of a burst of the plurality of bursts corresponds to an end of a previous burst of the plurality of bursts.
Aspect 14: The method of any of Aspects 1-13, further comprising mapping a coded block associated with the transport block to the plurality of bursts using a non-continuous mapping with an offset.
Aspect 15: The method of Aspect 14, wherein a start of a burst of the plurality of bursts is delayed by the offset with respect to a start of a previous burst of the plurality of bursts.
Aspect 16: The method of any of Aspects 1-15, further comprising applying transport block segmentation such that each burst of the plurality of bursts is separately decodable and is appended with one or more CRC bits.
Aspect 17: The method of Aspect 16, further comprising receiving feedback information associated with each burst of the plurality of bursts.
Aspect 18: The method of any of Aspects 1-17, further comprising receiving an indication to terminate transmission of the transport block, the indication being received prior to transmitting a last burst of the plurality of bursts.
Aspect 19: The method of any of Aspects 1-18, further comprising encoding the transport block using Miller coding, wherein a sequence for a first symbol of a burst of the plurality of bursts is based at least in part on a last symbol of a previous burst of the plurality of bursts.
Aspect 20: The method of Aspect 19, wherein encoding the transport block comprises inserting a bit indicating termination of the Miller coding at an end of a last burst of the plurality of bursts.
Aspect 21: The method of any of Aspects 1-20, further comprising transmitting an indication associated with initiating a subsequent transmission for transmitting a portion of the transport block.
Aspect 22: The method of Aspect 21, wherein the indication includes at least one of an end-of-signaling or an extended preamble.
Aspect 23: The method of Aspect 21, wherein the indication indicates that the transport block was partially transmitted and includes a request for scheduling the subsequent transmission for transmitting the portion of the transport block.
Aspect 24: The method of Aspect 21, further comprising receiving an indication to transmit the subsequent transmission including the portion of the transport block.
Aspect 25: An apparatus for wireless communication at a device, comprising a processor; memory coupled with the processor; and instructions stored in the memory and executable by the processor to cause the apparatus to perform the method of one or more of Aspects 1-24.
Aspect 26: A device for wireless communication, comprising a memory and one or more processors coupled to the memory, the one or more processors configured to perform the method of one or more of Aspects 1-24.
Aspect 27: An apparatus for wireless communication, comprising at least one means for performing the method of one or more of Aspects 1-24.
Aspect 28: A non-transitory computer-readable medium storing code for wireless communication, the code comprising instructions executable by a processor to perform the method of one or more of Aspects 1-24.
Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A passive backscatter device for wireless communication, comprising:
memory; and
one or more processors, coupled to the memory, configured to:
receive a configuration associated with transmitting a transport block using discontinuous backscattering; and
transmit the transport block using discontinuous backscattering based at least in part on the configuration, the transport block being transmitted over a plurality of bursts.

2. The passive backscatter device of claim 1, wherein the configuration indicates at least one of a transport block size, a reference backscatter link rate, a quantity of bursts, a time interval between bursts, or a maximum per-burst transmission duration.

3. The passive backscatter device of claim 2, wherein the configuration indicates the maximum per-burst transmission duration, and wherein the maximum per-burst transmission duration is associated with the reference backscatter link rate.

4. The passive backscatter device of claim 2, wherein the configuration indicates the reference backscatter link rate, and wherein the reference backscatter link rate is associated with a frequency for switching load impedances of the passive backscatter device.

5. The passive backscatter device of claim 1, wherein an actual backscatter link rate associated with transmitting the transport block is higher than a reference backscatter link rate indicated by the configuration, and an actual transmission duration of a burst of the plurality of bursts is shorter than a maximum per-burst transmission duration indicated by the configuration, and wherein the actual backscatter link rate depends on an amount of power harvested by the passive backscatter device and an estimated power consumption for backscattering.

6. (canceled)

7. The passive backscatter device of claim 1, wherein a mapping between an actual transmission duration of a burst of the plurality of bursts and an actual backscatter link rate associated with transmitting the transport block is predefined.

8. The passive backscatter device of claim 1, wherein the one or more processors are further configured to transmit control information indicating at least one of an actual transmission duration of a burst of the plurality of bursts or an actual backscatter link rate associated with transmitting the transport block, and wherein the control information is transmitted at a start of a first-in-time burst of the plurality of bursts and using a reference backscatter link rate.

9. (canceled)

10. The passive backscatter device of claim 1, wherein the configuration is pre-configured on the passive backscatter device.

11. The passive backscatter device of claim 1, wherein the configuration is included in a command that triggers the passive backscatter device to transmit the transport block using discontinuous backscattering.

12. The passive backscatter device of claim 1, wherein the one or more processors are further configured to map a coded block associated with the transport block to the plurality of bursts using a continuous mapping, and wherein a start of a burst of the plurality of bursts corresponds to an end of a previous burst of the plurality of bursts.

13. (canceled)

14. The passive backscatter device of claim 1, wherein the one or more processors are further configured to map a coded block associated with the transport block to the plurality of bursts using a non-continuous mapping with an offset, and wherein a start of a burst of the plurality of bursts is delayed by the offset with respect to a start of a previous burst of the plurality of bursts.

15. (canceled)

16. The passive backscatter device of claim 1, wherein the one or more processors are further configured to apply transport block segmentation such that each burst of the plurality of bursts is separately decodable and is appended with one or more cyclic redundancy check (CRC) bits, and wherein the one or more processors are further configured to receive feedback information associated with each burst of the plurality of bursts.

17. (canceled)

18. The passive backscatter device of claim 1, wherein the one or more processors are further configured to receive an indication to terminate transmission of the transport block, the indication being received prior to transmitting a last burst of the plurality of bursts.

19. The passive backscatter device of claim 1, wherein the one or more processors are further configured to encode the transport block using Miller coding, wherein a sequence for a first symbol of a burst of the plurality of bursts is based at least in part on a last symbol of a previous burst of the plurality of bursts, and wherein the one or more processors, to encode the transport block, are configured to insert a bit indicating termination of the Miller coding at an end of a last burst of the plurality of bursts.

20. (canceled)

21. The passive backscatter device of claim 1, wherein the one or more processors are further configured to transmit an indication associated with initiating a subsequent transmission for transmitting a portion of the transport block.

22. The passive backscatter device of claim 21, wherein the indication includes at least one of an end-of-signaling or an extended preamble.

23. The passive backscatter device of claim 21, wherein the indication indicates that the transport block was partially transmitted and includes a request for scheduling the subsequent transmission for transmitting the portion of the transport block.

24. The passive backscatter device of claim 21, wherein the one or more processors are further configured to receive an indication to transmit the subsequent transmission including the portion of the transport block.

25. A method of wireless communication performed by a passive backscatter device, comprising: receiving a configuration associated with transmitting a transport block using discontinuous backscattering; and
transmitting the transport block using discontinuous backscattering based at least in part on the configuration, the transport block being transmitted over a plurality of bursts.

26-28. (canceled)

29. An apparatus, comprising:
means for receiving a configuration associated with transmitting a transport block using discontinuous backscattering; and
means for transmitting the transport block using discontinuous backscattering based at least in part on the configuration, the transport block being transmitted over a plurality of bursts.

30. (canceled)
